(19) United States
(12) Patent Application Publication
(10) Pub. No.: US 2014/0033936 A1
(43) Pub. Date: Feb. 6, 2014

(54) PRINTING HEAD AND CHAMFER PRINTING SYSTEM

(71) Applicant: HON HAI PRECISION INDUSTRY CO., LTD., New Taipei (TW)

(72) Inventors: CHING-CHOU CHANG, New Taipei (TW); HSIN-CHIN HUNG, New Taipei (TW)

(73) Assignee: HON HAI PRECISION INDUSTRY CO., LTD., New Taipei (TW)

(21) Appl. No.: 13/726,238

(22) Filed: Dec. 24, 2012

(30) Foreign Application Priority Data
Jul. 31, 2012 (TW) 101127649

(51) Int. Cl. B41F 27/12

(52) U.S. Cl. CPC B41F 27/12
USPC 101/150

(57) ABSTRACT

A printing head is configured for printing a chamfer of a substrate, and includes a bottom surface. The printing head defines a recess on the bottom surface. The recess includes an inclined inner surface corresponding to the chamfer. The inner surface is configured for contacting with the chamfer.

### BACKGROUND

1. Technical Field

The present disclosure relates to printing heads, and particularly to a printing head capable of printing a chamfer and a chamfer printing system using the printing head.

2. Description of Related Art

Substrates generally define a chamfer on an edge thereof. In order to improve optical performance or artistic effect, the chamfer is covered by a layer of ink by printing. However, current printing heads just can be used to print on a flat surface.

Therefore, it is desirable to provide a printing head and a chamfer printing system, which can overcome the limitations described.

### BRIEF DESCRIPTION OF THE DRAWINGS

FIG. 1 is a function block view of a chamfer printing system in accordance with an exemplary embodiment.

FIG. 2 shows the operation of a printing head of the chamfer printing system of FIG. 1 on a chamfer of a substrate.

### DETAILED DESCRIPTION

Embodiments of the disclosure will be described with reference to the drawings.

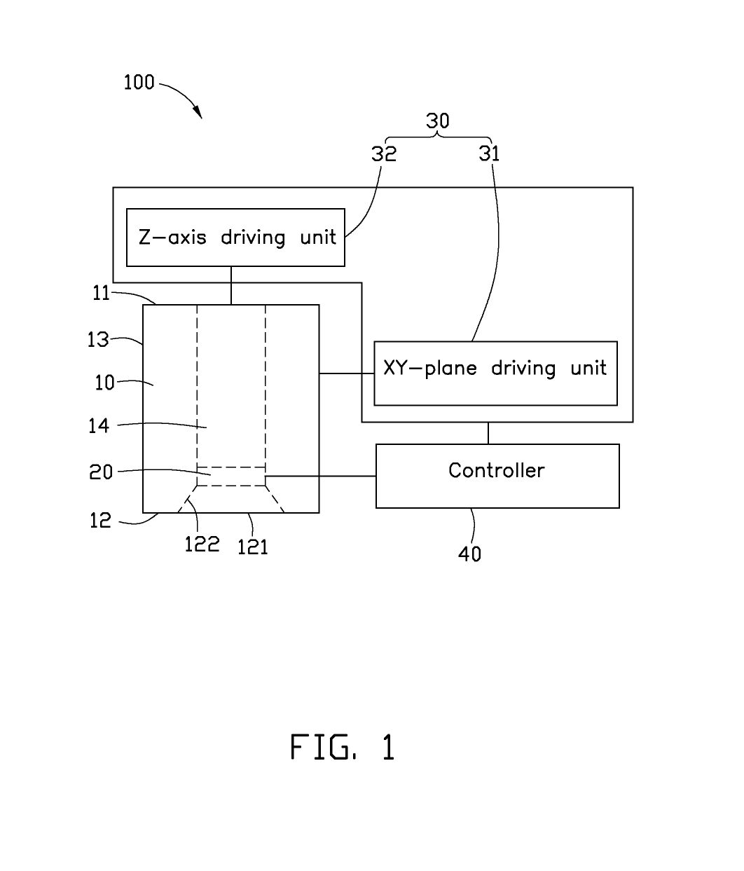

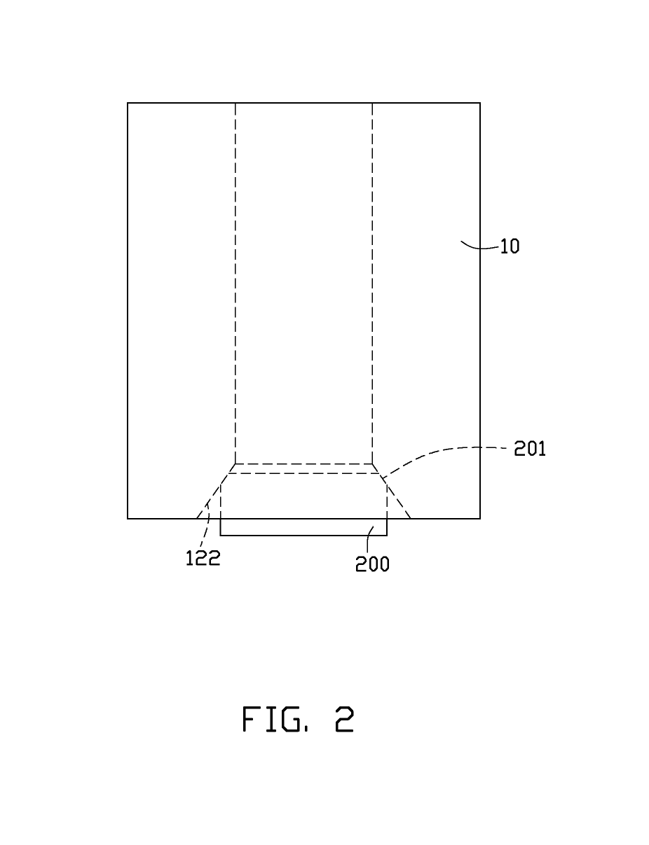

FIGS. 1-2 shows a chamfer printing system 100 according to an exemplary embodiment. The chamfer printing system 100 is used to print a printing ink on a chamfer 201 of a substrate 200. The chamfer printing system 100 includes a printing head 10, an image capturing module 20, a driving device 30, and a controller 40. In the embodiment, the substrate 200 is cylindrical shaped and made of sapphire.

The printing head 10 is a cylindrical, includes a top surface 11, a bottom surface 12 opposite to the top surface 11, and a cylindrical surface 13 connected between the top surface 11 and the bottom surface 12. The printing head 10 defines a through hole 14 penetrating through the top surface 11 and the bottom surface 12. The through hole 14 is generally defined at a center of the printing head 10. The printing head 10 defines a recess 121 on the bottom surface 12, and the recess 121 communicates with the through hole 14. The shape of the recess 121 is corresponding to the shape of the substrate 200. The recess 121 includes an inclined inner surface 122. The inclined angle of the inner surface 122 is equal to that of the chamfer 201.

In the embodiment, the recess 121 is a frustum cone, and the diameter of the recess 121 decreases along a direction from the bottom surface 12 to the top surface 11. A base diameter of one end of the recess 121 adjacent to the bottom surface 12 is greater than the diameter of the substrate 200, and a cap diameter of another end of the recess 121 away from the bottom surface 12 is less than the diameter of the substrate 200.

The image capturing module 20 is received in the through hole 14, and aims at the bottom surface 12. The image capturing module 20 is configured for capturing an image of an area below the printing head 10. The filed angle of the image capturing module 20 is less than an angle formed by the inner surface 122 of the recess 121. In the embodiment, the image capturing module 20 can be a complementary metal-oxide semiconductor (CMOS) sensor or a charge coupled device (CCD) sensor.

The driving device 30 includes an XY-plane driving unit 31 and a Z-axis driving unit 32. The XY-plane driving unit 31 and the Z-axis driving unit 32 are respectively coupled to the printing head 10. The XY-plane driving unit 31 drives the printing head 10 to move on an XY-plane that is parallel with the bottom surface 12. The Z-axis driving unit 32 drives the printing head 10 to move along a Z-axis that is perpendicular to the bottom surface 12. In the embodiment, the XY-plane driving unit 31 is engaged with the cylindrical surface 13, and the Z-axis driving unit 32 is engaged with the top surface 11.

The controller 40 is electrically connected to the image capturing module 20 and the driving device 30. The controller 40 receives the images captured by the image capturing module 20, and finds a center point of an object of the images by analyzing the captured images. In the embodiment, the controller 40 analyzes the captured image by the methods of gray-level transformation, binarization, and geometrical analysis. In the embodiment, the edge of the substrate 200 and the center point of the substrate 200 can easily be acquired by the image analysis as the substrate 200 has the chamfer 201 printed on the edge. The controller 10 controls the XY-plane driving unit 31 and the Z-axis driving unit 32 to move the printing head 10.

In use, a printing ink is evenly printed on the inner surface 122. The substrate 200 is placed under the printing head 10, and the controller 40 controls the image capturing module 20 capturing an image of the substrate 200. The controller 40 receives the captured image from the image capturing module 20, and finds the center point of the substrate 200 of the captured image.

The controller 40 controls the XY-plane driving unit 31 to drive the printing head 10 to move on the XY-plane; therefore the center of the printing head 10 is aligned with the center point of the substrate 200. Then, the controller 40 controls the Z-axis driving unit 32 to drive the printing head 10 to move along the Z-axis as the inner surface 122 of the printing head 10 contacts the chamfer 201 of the substrate 200. Therefore, the printing ink printed on the inner surface 122 is evenly printed on the chamfer 201 of the substrate 200.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A printing head for printing a chamfer of a substrate, comprising:
a bottom surface;
the printing head defining a recess on the bottom surface, the recess comprising an inclined inner surface corresponding to the chamfer, the inclined inner surface configured for contacting with the chamfer.

2. The printing head of claim 1, wherein the shape of the recess is corresponding to the shape of the substrate.

3. The printing head of claim 1, wherein the printing head comprises a top surface opposite to the bottom surface, the printing head defines a through hole penetrating through the top surface and the bottom surface.

4. The printing head of claim 3, wherein the recess communicates with the through hole.

5. The printing head of claim 3, wherein the recess is a frustum cone in shape, and a diameter of the recess decreases along a direction from the bottom surface to the top surface.

6. A chamfer printing system for printing a chamfer of a substrate, comprising:
a printing head comprising a bottom surface, the printing head defining a recess on the bottom surface, the recess comprising an inclined inner surface corresponding to the chamfer;
an image capturing module configured for capturing an image of the substrate;
a driving device driving the printing head to move on a plane parallel with the bottom surface and to move along an axis perpendicular to the bottom surface; and
a controller acquiring the position of a center point of the substrate based on the captured image and controlling the driving device to drive the printing head according to the position of the center point, such that the inclined inner surface of the recess contacts with the chamfer of the substrate, and a center of the printing head is aligned with the center point of the substrate.

7. The chamfer printing system of claim 6, wherein the shape of the recess is corresponding to the shape of the substrate.

8. The chamfer printing system of claim 6, wherein the printing head comprises a top surface opposite to the bottom surface, and the printing head defines a through hole penetrating through the top surface and the bottom surface.

9. The chamfer printing system of claim 8, wherein the recess communicates with the through hole.

10. The chamfer printing system of claim 8, wherein the recess is a frustum cone in shape, and a diameter of the recess decreases along a direction from the bottom surface to the top surface.
